(19) United States
(12) Patent Application Publication
(10) Pub. No.: US 2026/0159051 A1
(43) Pub. Date: Jun. 11, 2026

(54) METHOD FOR CARRYING OUT A SITUATION-CONTINGENT BRAKING OPERATION OF A VEHICLE BY MEANS OF AN ELECTRONIC PARKING BRAKE, ELECTRONIC BRAKING SYSTEM AND MOTOR VEHICLE

(71) Applicant: VOLKSWAGEN AKTIENGESELLSCHAFT, Wolfsburg (DE)

(72) Inventors: Halit ALAGÖZ, Hannover (DE); Florian GÄHLE, Hannover (DE); Christopher PROTZE, Wolfsburg (DE)

(21) Appl. No.: 19/127,193

(22) PCT Filed: Nov. 1, 2023
(86) PCT No.: PCT/EP2023/080497

§ 371 Date: May 5, 2025

(30) Foreign Application Priority Data
Nov. 3, 2022 (DE) 10 2022 211 629.1

(51) Int. Cl. B60T 8/172; B60T 8/171; B60T 8/174; B60T 13/74

(52) U.S. Cl. CPC B60T 8/172; B60T 8/171; B60T 8/174; B60T 13/74; B60T 2210/32; B60T 2220/04; B60T 2250/00

(57) ABSTRACT

A method for carrying out a braking operation of a vehicle includes: detecting that an electric parking brake of the vehicle has been actuated by an occupant of the vehicle during travel of the vehicle; acquiring environmental information in an environment of the vehicle; determining a braking strategy on the basis of the environmental information and on the actuated electric parking brake by an evaluating unit; and carrying out the braking operation on the basis of the determined braking strategy. There is also described an electric braking system and a vehicle with such a braking system.

The invention relates to a method for carrying out a braking operation of a vehicle.

The invention further relates to an electronic braking system with a sensing unit, an evaluating unit and an electric parking brake. The invention also relates to a motor vehicle with an electronic braking system.

Vehicles have a wide variety of safety systems to increase the safety of vehicles. Manually operated vehicles have a brake pedal for carrying out a braking operation of the vehicle, which may be actuated by the driver of the vehicle to brake the vehicle. As a result of safety-related and legal requirements, vehicles have a further or second actuating unit in addition to a brake pedal. This may be the parking brake or handbrake or parking brake button. This may be triggered to brake the vehicle. For this second actuating unit, a fixedly defined delay value is specified or set.

US 2021/0107621 A1 describes a vehicle control system. This system has a first unit for determining a destination trajectory for automated driving of a vehicle. A second unit is provided to be able to autonomously control the vehicle to the destination in accordance with the trajectory ascertained. Moreover, US 2019/0061772 A1 discloses a system for monitoring a state of health of a vehicle occupant. Therein, physiological parameters may be sensed via a unit which may be worn by the passengers. A state of health of the passenger may be determined using a diagnostics module in accordance with the sensed parameters.

One object of the present invention is to be able to carry out a braking operation of a vehicle which has been triggered manually by a passenger of the vehicle in a safer manner.

This object is achieved by a method, an electronic braking system and a vehicle according to the independent claims. Reasonable developments result from the dependent claims.

One aspect of the invention relates to a method for carrying out a braking operation of a vehicle, wherein the following steps are carried out: detecting an actuation of an electric parking brake of the vehicle by an occupant of the vehicle during travel of the vehicle; sensing at least one piece of environment information in an environment of the vehicle; determining a braking strategy on the basis of the at least one piece of environment information and of the actuated electric parking brake by means of an evaluating unit; carrying out the braking operation on the basis of the determined braking strategy.

By means of the proposed method, a braking operation of a vehicle which has been triggered by an occupant of the vehicle may be carried out or executed in a safer manner, in particular safe for traffic. By determining the braking strategy based on the piece of environment information, that is, due to information in the environment of the vehicle, the braking operation may be carried out depending on the situation, that is, in a manner adapted to the respective situation, so that this braking operation may be carried out such that, for example, there are no collisions, near misses or any other events adversely affecting the occupants.

By sensing the at least one piece of environment information or several pieces of environment information in the environment or in the surroundings of the vehicle, the respective situation the vehicle is experiencing may be analyzed. Thereby, a braking operation adapted to the situation and corresponding to the situation may be carried out. Thus, rear-end collisions may be prevented, for example. By means of a detection unit or a sensing unit, the actuation or triggering or activation of the electric parking brake may be detected or sensed. This involves manual actuation by the occupant of the vehicle. The electric parking brake may be actuated by the driver or by a front passenger. In the event that, for example, the driver of the vehicle is no longer able to operate the vehicle, the front passenger may actuate the electric parking brake so that a safe braking operation may be carried out dependent on the braking strategy. Likewise, the driver, who is at least partially unfit to drive, may actuate the electric parking brake to safely move the vehicle to a standstill. Thus, a wide variety of situations or circumstances may be taken into account to decelerate the vehicle and safely bring it to a standstill without endangering the surrounding traffic.

The electric parking brake (EPB), also referred to as an automatic parking brake, slows down the vehicle by means of actuators on the rear brake of the vehicle and a controller. In particular, the electric parking brake is actuated manually by a human rather than in an automatic or automated manner by a system.

The electric parking brake may be arranged, for example, as a button, such as a push-pull button or push button in the region of the center console, in the interior of the vehicle so that it is accessible to all occupants of the vehicle.

The evaluating unit may be, in particular, an electronic evaluating unit or an electronic computing unit. With the aid of the evaluating unit, the braking strategy may be ascertained or determined and transferred or transmitted to the electric parking brake and/or an electronic braking system of the vehicle so that the braking operation may be carried out or initiated.

In one exemplary embodiment, it is provided that a period of time for how long an actuating element of the electric parking brake is actuated by the occupant is determined, wherein the determined period of time is taken into account when determining the braking strategy. In addition or instead, the braking operation may be carried out as long as the actuating element is actuated. The braking strategy may be adapted to the respective situation by determining or measuring the period of time. For example, in the case of a short period of time or actuation period of the actuating element of the electric parking brake, urgency may be less important for carrying out the braking operation. In the case of a very short period of time, it may further be detected or established that the actuating element might have been actuated by mistake or unintentionally. By taking this into account, it is possible above all to prevent a rapid braking operation, in particular an emergency braking operation, from being carried out, and in particular to prevent a vehicle travelling behind the vehicle from colliding with the rear end of the vehicle as it does not have sufficient reaction time available. The occupants may also be protected by a rapid braking operation and the forces acting on the occupants in the process.

If, in turn, a long period of time or a permanent actuation of the actuating element is determined or detected, it may be concluded that a dangerous situation, an emergency or an emergency situation is present and that a braking operation must be carried out urgently. This may be taken into account or additionally taken into account in the determination of the braking strategy so that the braking operation may be carried out in a manner adapted to the respective situation. Further, the braking operation, which is carried out by the electric parking brake, may be carried out or maintained as long as the actuating element is actuated. The occupant may thus actuate the actuating element until the vehicle has actually been safely brought to a standstill.

The actuating element may be, for example, a button or any other operating element in the region of the center console of the vehicle.

In one exemplary embodiment, it is provided that navigation information and/or information of further vehicles in the environment are provided to the evaluating unit, wherein the navigation information and/or the information of the further vehicle are taken into account when determining the braking strategy. By means of this information, further extensive information or data may be made available to the evaluating unit to be able to determine or ascertain the braking strategy in a manner which is adapted more to the situation. The evaluation information may be provided to the evaluating unit by a navigation system of the vehicle or by a navigation system of an occupant of the vehicle. This may be, in particular, map data of a digital map. The navigation information may allow, for example, to react early to an upcoming obstacle, to a curve, a traffic light, a traffic jam or any other danger potential along or on or in a region of the route or itinerary of the vehicle during travel. The information of the further vehicles may be made available to the evaluating unit, for example, further surroundings information which has been sensed by sensor units of the further vehicles. Further, the further vehicles may make their current position and their further course of travel available to the evaluating unit. From this information, the braking strategy may be better tailored to the respective situation or to the respective environment of the vehicle so that there is no danger to the occupants of the vehicle and to the further vehicles or other road users during the braking operation. The information of the further vehicles may be transmitted, for example, via communication connections between the vehicles. For example, a car-2-car or a car-2-X communication connection may be used.

In one exemplary embodiment, it is provided that a braking trajectory is determined on the basis of a current trajectory of the vehicle and of the at least one piece of environment information, wherein the braking operation is carried out on the basis of the determined or generated braking trajectory. To be able to carry out the braking operation safely for the occupants of the vehicle and for the further road users located in the environment of the vehicle, the braking trajectory may be ascertained or generated. On the basis of the piece of environment information, that is, of the environment or of the surroundings of the vehicle, for example, the route section ahead may be assessed or analyzed so that this information the braking trajectory is generated using the trajectory of the vehicle which is currently being traversed and/or a past trajectory of the vehicle. The braking trajectory may be used to characterize a safe braking distance. The braking trajectory may also be added to the braking strategy so that a safe braking operation may be carried out. With the aid of the braking trajectory, a braking distance or a braking route may be ascertained or predicted.

When carrying out the braking operation by means of the electric parking brake, on the one hand, a deceleration or a braking of the vehicle may be carried out or may be carried out dynamically, and by means of the braking trajectory, sideways movements or lateral movements, that is, the transverse guidance, of the vehicle may be influenced. In this case, either steering interventions or steering operations may be conducted from the system side by a safety system of the vehicle. It is also conceivable that acoustic, optical and/or haptic indications or instructions for action are output to the occupants of the vehicle so that corresponding steering interventions may be conducted by the occupants. Thus, when carrying out the braking operation, it may be achieved that the vehicle does not deviate from the roadway and thus does not accidentally veer into the opposite roadway or into any other roadway.

In one exemplary embodiment, it is provided that the occupants of the vehicle, which are located in a passenger compartment of the vehicle, are sensed using an interior sensing unit, wherein a state and/or a behavior of at least one occupant of the occupants is determined on the basis of the sensed occupants. The state and/or the behavior of the at least one occupant is taken into account when determining the braking strategy. In addition or instead, on the basis of the state and/or the behavior of the at least one occupant, a system-side intervention in a transverse guidance of the vehicle may be carried out. The at least one occupant or all occupants of the vehicle may be continuously monitored with the aid of the interior sensing unit or an interior camera. Sensed information may be made available to the interior sensing unit of the evaluating unit so that the state and/or the behavior may be ascertained or determined on the basis of the sensed occupants or the sensed information. The state is understood to mean, for example, a tiredness state, an attentiveness state, a state of health, a state of illness, an unfitness to drive, a temporary limitation or other body-related or psychological or physical limitations of an occupant of the vehicle. Consequently, it may thus be established whether at least one of the occupants has a state or behavior which is dangerous or hazardous to their health and this is taken into account in the braking strategy. If, for example, it is established that at least one occupant has passed out, is injured or has suffered a stroke, for example, the braking strategy is determined such that a safe, but nevertheless rapid braking operation is carried out instantly to safely bring the vehicle to a standstill as quickly as possible.

Above all, the behavior or the state of the at least one occupant, that is, for example, of the driver, may be checked here. If it is established that the driver is no longer able to carry out steering operations or any other actuations for controlling the vehicle, then a system-side intervention in the transverse guidance of the vehicle may be conducted by a safety system of the vehicle so that the vehicle above all does not deviate from the lane. Further, physical and/or psychological parameters regarding the occupants of the vehicle may be sensed using further sensor systems and may also be taken into account in the determination of the braking strategy.

In one exemplary embodiment, it is provided that the environment of the vehicle and/or a state of the vehicle is sensed during travel so that dynamic predicting of a prediction braking strategy may be continuously performed during travel, wherein the prediction braking strategy may be taken into account when determining the braking strategy for the actuated electric parking brake. Thus, with the aid of the prediction braking strategy, preconditioning of the vehicle, of an electric braking system and/or of the electric parking brake may be conducted. For this purpose, continuous sensing of the environment of the vehicle and of the state of the vehicle may be conducted. Thus, for a respective time or situation, a predictive braking strategy to this respective current situation may be determined continuously. Although, in turn, this may change at any time, these precomputed or predetermined strategies may be taken into account in a later determination of a braking strategy so that a respective braking strategy may be determined more quickly and more efficiently. The state of the vehicle is understood to mean, for example, a state of a vehicle system, of a vehicle component, of a braking system, of the electric parking brake or of any other vehicle system. These may impair a deceleration carried out or a braking of the vehicle carried out so that, for example, the braking distance could be extended. This may be taken into account in the determination of the braking strategy as in this case a braking operation must be carried out earlier and more strongly to be able to compensate for this current state.

In one exemplary embodiment, it is provided that, when detecting the actuation of the electric parking brake, it is checked whether or not a braking operation is to be carried out due to a current traffic situation and/or vehicle situation and/or occupant situation. This checking may detect unintentional actuations of the electric parking brake so that an undesired braking operation does not occur. In addition to the traffic situation, the vehicle situation and/or the occupant situation, it may be checked from the system side whether the actuation of the electric parking brake is appropriate for the current situation and whether a braking intention was actually desired by an occupant or whether at least one of the occupants has actuated the parking brake by mistake. Further, it may be established that an actuating element of the electric parking brake might be defective.

In one exemplary embodiment, it is provided that the braking strategy is used to characterize a braking force for at least one braking equipment of the vehicle, a braking duration, a braking intensity, a starting time and/or a type of the braking operation. With the aid of the braking strategy, a braking operation which is adapted to the situation and is appropriate for the respective time may be carried out in a highly versatile manner. Relating to the type of braking operation, a distinction may be made, for example, between a normal braking operation and an emergency braking operation.

A further aspect of the invention relates to an electronic braking system with a sensing unit, an evaluating unit and an electric parking brake, wherein the electronic braking system is configured for carrying out a method of any previous aspect or any advantageous development thereof. In particular, using the electronic braking system previously described, a method of the previous aspect or an advantageous development thereof may be executed.

The electronic or electric braking system or braking device of the vehicle may have the sensing unit for sensing an actuation of the electric parking brake. Further, the electronic braking system may have the evaluating unit, in particular an electronic evaluating unit. Further, the electronic braking system may have further braking units, actuators or braking equipment.

A further aspect of the invention relates to a vehicle with an electronic braking system of the previous aspect or any advantageous development.

The vehicle may be a manually operated vehicle. In particular, the vehicle is a motor vehicle, such as a passenger vehicle or a truck.

A surroundings sensor system may be understood to mean, for example, a sensor system which is able to generate sensor data or sensor signals which image, represent or reproduce an environment of the surroundings sensor system. In particular, the ability to sense electromagnetic or other signals from the environment is not sufficient to deem a sensor system a surroundings sensor system. For example, cameras, radar systems, lidar systems or ultrasonic sensor systems may be considered to be surroundings sensor systems.

A computing unit may be understood to mean, in particular, a data processor containing a processing circuit. The computing unit may thus in particular process data for carrying out computing operations. This may also involve, if appropriate, operations to carry out indexed access to a data structure, for example a look-up table, LUT.

The computing unit may in particular contain one or more computers, one or more microcontrollers and/or one or more integrated circuits, for example one or more application-specific integrated circuits, ASICs, one or more field-programmable gate arrays, FPGAs, and/or one or more systems on a chip, SoCs. The computing unit may also contain one or more processors, for example one or more microprocessors, one or more central processing units, CPUs, one or more graphics processing units, GPUs, and/or one or more signal processors, in particular one or more digital signal processors, DSPs. The computing unit may also include a physical or virtual group of computers or any others of the mentioned units.

In various exemplary embodiments, the computing unit contains one or more hardware and/or software interfaces and/or one or more memory units.

For application cases or application situations which may arise in the method and which are not explicitly described here, it may be provided that an error message and/or a prompt for input of user feedback is output and/or a standard setting and/or a predetermined initial state is set according to the method.

The invention also encompasses developments of the electronic braking system according to the invention and of the motor vehicle according to the invention which have features as already described in connection with the developments of the method according to the invention. For this reason, the corresponding developments of the electronic braking system according to the invention and of the motor vehicle according to the invention are not described again here.

The invention also comprises the combinations of the features of the embodiments described.

Exemplary embodiments of the invention are described in the following. In the drawings:

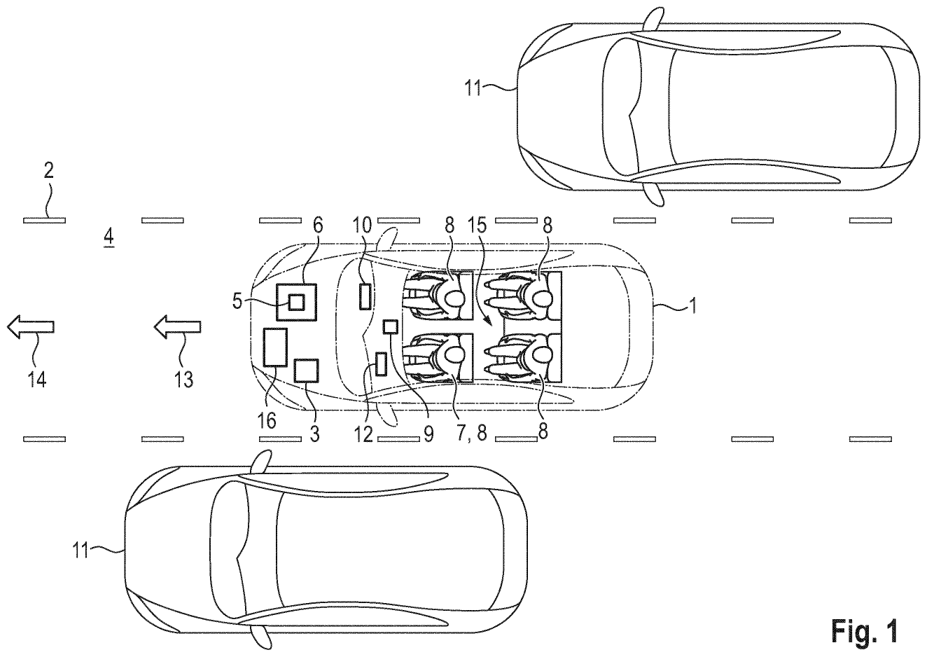

FIG. 1 shows a schematic representation of a vehicle with an electric parking brake;

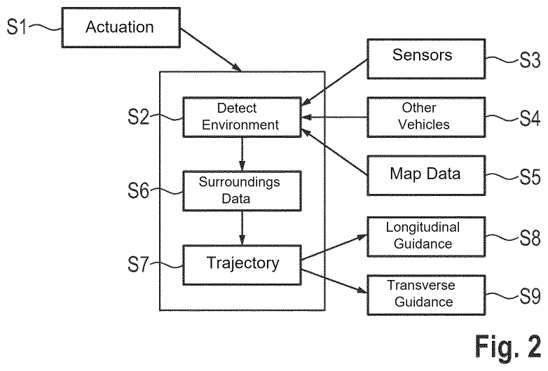

FIG. 2 shows a schematic sequence of a braking operation by means of the actuated electric parking brake of FIG. 1.

The exemplary embodiments explained in the following are preferred exemplary embodiments of the invention. In the exemplary embodiments, the described components constitute individual features of the invention which are to be considered independently of each other, each also developing the invention further independently of each other and, therefore, to be regarded as a part of the invention individually or in any combination different from the one shown. Further, the exemplary embodiments described are also supplementable by further ones of the features of the invention already described.

In the figures, functionally identical elements are each provided with the same reference numerals.

FIG. 1 schematically represents a vehicle 1 which travels along a lane 2 during travel. In particular, the vehicle 1 is operated or controlled manually. In addition to the conventional braking equipment activated by actuation of a brake pedal by a driver, the vehicle 1 may have an electric parking brake 3. This may function as an additional or further braking unit of the vehicle 1.

At least one piece of information in an environment 4 of the vehicle 1 may be sensed during travel of the vehicle 1. In doing so, the respective traffic status or traffic situation may be assessed or evaluated. This information may be provided or transferred to an evaluating unit 5 or an electronic evaluating unit. The evaluating unit 5 may be a constituent of an electronic braking system of the vehicle, for example. It is also conceivable that the evaluating unit 5 is configured to be external to the vehicle and is designed, for example, as a back end, server or data cloud and is communicatively networked with the electronic braking system 6.

During travel of the vehicle 1, it may occur, for example, that the occupant 7 of the vehicle 1, who is located in a passenger interior 15 of the vehicle 1, has mental, physical, psychological or other health problems. For example, the occupant 7 may be the driver of the vehicle 1. If the driver 7, due to their current state of health, is no longer able to control or steer the vehicle 1 safely as they have passed out, for example, then a braking action could be initiated or an emergency braking action could be initiated by an occupant 8, for example the front passenger of the vehicle 1. For this purpose, an actuating element 9 of the electric parking brake 3 may be manually actuated by an occupant 8. This actuation 9 may be sensed or detected from the vehicle side so that a piece of information is available that a braking operation is to be carried out immediately. For this purpose, at least one braking strategy or several braking strategies may be determined with the aid of the evaluating unit 5 on the basis of the at least one piece of environment information and of the actuation of the parking brake 3. Based on this braking strategy, a braking operation may be carried out, in particular by the electronic braking system or the electric parking brake 3. Thus, for example, a driver or a front passenger or an occupant 8 may express a braking intention by actuation of the operating element of the electric parking brake 3, which may be carried out by means of the electric parking brake 3 taking into account the environment 4 and in particular sensor data. To be able to better judge or assess the environment 4 above all, further information may be made available to the evaluating unit 5 for determining the braking strategy. For example, navigation information, navigation data and/or map data of a navigation system 10 of the vehicle 1 may be taken into account. A further parameter or a further important piece of information to be able to carry out a safe braking operation may be information of further vehicles 11 in the environment 4. For example, the further vehicles 11 may be located in adjacent lanes to the lane 2. This is advantageous for the case of the braking operation as it may be ensured that no dangerous impairment of the adjacent vehicles 11 occurs when carrying out the braking operation.

Further, the occupants 8 may be continuously sensed by means of an interior sensing unit 12 so that, for example, a driver 7 who may be unconscious, passed out or asleep may be detected early on. For this purpose, for example, an acoustic, haptic or visual alert may be output to the further occupants 8 so that they actuate the electric parking brake 3, for example. Otherwise, this piece of information may additionally be taken into account in the determination of the braking strategy if the other occupants 8 have already actuated the actuating element 9. Thus, the vehicle knows that an actual emergency situation is currently present and the driver 7 is unfit to drive and the braking operation must be carried out rapidly. In particular, an emergency trajectory or an emergency braking operation may be triggered with the aid of the actuating element 9 of the electric parking brake 3.

Further, in one embodiment, it is conceivable that the actuating element 9 of the electric parking brake 3 is replaced by a combined parking lock/parking brake button. A soft key via a display of the vehicle 1 would also be conceivable. In a further embodiment, the actuating element 9 may be executed via the parking lock button.

For example, the front passenger of the vehicle 1 may initiate a braking operation in the case of a collapsed driver 7 by means of the actuating element 9. In the case of such a collapsed driver 7, an additional system-side confirmation of the evaluating unit 5 may be made available, for example, with the interior sensing unit. In this case, the sideways movement may be corrected by the vehicle from the system side. In other words, situation-contingent emergency braking may be conducted or activated or triggered with the aid of the operating element 9 or parking operating element.

To be able to perform the braking operation in a better or more efficient and safer way, a braking trajectory 14 may be determined on the basis of a current trajectory 30 13 of the vehicle 1 and of the at least one piece of environment information, which may be used to characterize a safe braking distance. This trajectory may be adhered to before and during the braking operation. If the driver 7 or any other occupant 8 is still fit to drive, instructions may be given by means of warnings in the vehicle 1. Otherwise, system-side interventions may be conducted here.

In one exemplary embodiment, it may be provided that the vehicle 1 ascertains an ideal and safe trajectory, that is, the braking trajectory 14, for vehicle deceleration and for vehicle guidance from the following data:
usage of the vehicle sensorics for detecting the road of the environment 4 or of the surroundings, such as lane object detection by means of a camera, radar and/or lidar
usage of map data and communication data, for example by means of car-2-X communications
usage of the interior monitoring by means of the interior sensing unit 12 for establishing the ability of the driver 7 or of the occupants 8 to drive

If, for example, a collapsed driver 7 pulls the steering wheel towards a guard rail or a shoulder, then, when actuating the EPE button, in addition to the deceleration of the vehicle 1, the steering movement may additionally be corrected from the system side so that the vehicle 1 may be brought to a standstill in a safe and controlled manner.

The following FIG. 2 represents an exemplary embodiment of a sequence for a braking operation by an actuated electric parking brake 3.

In an exemplary first step S 1, the actuation of the electric parking brake 3 may be detected. Subsequently, in an optional second step S 2, the detection of the at least one piece of environment information in the environment 4 of the vehicle 1 may be conducted using a sensing unit 16. Thus, the surroundings are sensed here. Further, a surroundings sensing system of the vehicle 1 may be used for this purpose. The surroundings may be detected by sensors of the vehicle 1 in an optional third step S 3. In an optional fourth step S 4, surroundings information of further vehicles 11 in the environment 4 may be made available to the evaluating unit 5 by means of car-2-X communication systems. In a further optional fifth step S5, map data of the example navigation system 10 may be made available to the evaluating unit 5. In a subsequent optional sixth step S6, the surroundings data or the environment 4 may be evaluated by the evaluating unit 5. Subsequently, in an optional seventh step S7, the braking operation and/or the trajectory or the braking trajectory may be implemented. For this purpose, in an optional eighth step S8, the longitudinal guidance of the vehicle 1 may be adapted or altered. In an optional ninth step S9, the transverse guidance of the vehicle 1 may in turn be adapted or altered.

In particular, the exemplary embodiment of FIG. 2 shows sensor-based support for braking in an emergency situation of the vehicle 1.

### LIST OF REFERENCE NUMERALS

1 Vehicle
2 Lane
3 Electric parking brake
4 Environment
5 Evaluating unit
6 Electronic braking system
7 Driver
8 Occupants
9 Actuating element
10 Navigation system
11 Further vehicles
12 Interior sensing unit
13 Current trajectory
14 Braking trajectory
15 Passenger interior
16 Sensing unit

1-10. (canceled)

11. A method for carrying out a braking operation of a vehicle, the method comprising the following steps:
detecting an actuation of an electric parking brake of the vehicle by an occupant of the vehicle during travel of the vehicle;
acquiring at least one piece of environment information in an environment of the vehicle;
determining, by an evaluating unit, a braking strategy on a basis of the at least one piece of environment information and of the actuated electric parking brake; and
carrying out the braking operation on a basis of the braking strategy.

12. The method according to claim 11, which comprises determining a period of time for how long an actuating element of the electric parking brake is actuated by the occupant, and taking the period of time into account when determining the braking strategy.

13. The method according to claim 12, which comprises carrying out the braking operation as long as the actuating element is being actuated.

14. The method according to claim 11, which comprises providing the evaluating unit with at least one of navigation information or information of further vehicles in the environment, and taking at least one of the navigation information or the information of the further vehicles into account when determining the braking strategy.

15. The method according to claim 11, which comprises determining a braking trajectory on a basis of a current trajectory of the vehicle and of the at least one piece of environment information, and carrying out the braking operation on a basis of the braking trajectory.

16. The method according to claim 11, which comprises:
acquiring with an interior sensing unit occupants of the vehicle that are located in a passenger interior of the vehicle;
determining a state and/or a behavior of at least one occupant of the occupants in the vehicle; and
taking into account the state and/or the behavior of the at least one occupant when determining the braking strategy.

17. The method according to claim 16, which comprises, based on the state and/or the behavior of the at least one occupant, carrying out a system-side intervention in a transverse guidance of the vehicle.

18. The method according to claim 11, which comprises sensing at least one of the environment of the vehicle or a state of the vehicle during travel for continuously performing dynamic updating of a prediction braking strategy during travel, and taking into account the prediction braking strategy when determining the braking strategy for the actuated electric parking brake.

19. The method according to claim 11, which comprises, upon detecting that the electric parking brake has being actuated, checking whether or not a braking operation is to be carried out due to at least one situation selected from the group consisting of a current traffic situation, a current vehicle situation, and a current occupant situation.

20. The method according to claim 11, which comprises using the braking strategy to characterize at least one of a braking force for at least one braking equipment of the vehicle, a braking duration, a braking intensity, a starting time for the braking operation, or a type of the braking operation.

21. An electronic braking system, comprising a sensing unit, an evaluating unit, and an electric parking brake, and wherein the electronic braking system is configured for carrying out the method according to claim 11.

22. A vehicle, comprising an electronic braking system having a sensing unit, an evaluating unit, and an electric parking brake, and being configured for carrying out the method according to claim 11.
